(19) United States
(12) Patent Application Publication
(10) Pub. No.: US 2022/0012783 A1
(43) Pub. Date: Jan. 13, 2022

(54) SYSTEM AND METHOD WITH LOCAL AND AGGREGATED DATABASES, ASSISTED DATA ENTRY, AND TARGETED SEARCHING

(71) Applicant: RESALE GLOBAL, INC., Vienna, VA (US)

(72) Inventor: Carol LaFlamme, Fairfax Station, VA (US)

(21) Appl. No.: 16/924,165

(22) Filed: Jul. 8, 2020

(51) Int. Cl. G06Q 30/06; G06F 16/248; G06Q 10/08

(52) U.S. Cl. CPC G06Q 30/0605; G06Q 30/0625; G06Q 10/087; G06F 16/248

(57) ABSTRACT

An online consignment shopping system supports an aggregated marketplace for consignment vendors. The online consignment shopping system has a network interface and one or more processors. The system receives a request for a consignment article that has user-specified measurements. The system searches through one or more inventory databases for a match to the request. The inventory database(s) have inventories of a plurality of consignment vendors. The system sends information about the matching consignment article that has the user-specified measurements, for potential purchase by the user.

### TECHNICAL FIELD

The technical field of the present disclosure relates to database, searching and network communications technologies.

### BACKGROUND

Database, searching and network communications technologies are in widespread use. FIG. 1 is a prior art system architecture diagram for Internet searching. This architecture is related to and suitable for Internet search giants such as Google. Websites 109 on the network 122, with webpage generators 111, host webpages based on information from databases 113. A server farm 103, which can be geographically distributed on the network 122, has search engines 115 and web crawler engines 105. The web crawler engines 105 seek websites 109 and read webpages produced by the webpage generators 111, then store information from the webpages in the web crawler cache distributed database 107, which can also be geographically distributed. In response to a query from an app 101 on a user device 102, for example user entry through a browser executing on the user device 102, one or more of the search engines 115 searches through the web crawler cache distributed database 107. Information thus found is presented back to the app 101 on the user device 102, usually in the form of a first page of information summary and links to webpages, and a range of further pages of information summaries and links for optional user selection. Various algorithms are used to find, store, sort, rank and present the information and links. It is therein that some information and links are favored for presentation on that first page of information summary and links to webpages, and some information and links are relegated to later search results pages that are less often viewed by users. One phenomenon is that information that does not receive a top rank or paid placement is less often seen by users. The system architecture of FIG. 1 thus provides access to essentially all of the information on the Internet, with initial results presented much more rapidly due to the use of the web crawler cache distributed database 107 rather than each individual search having to go through the databases 113 at the websites 109. But the system architecture of FIG. 1 has the disadvantage of disfavoring much of that information as an artifact of the ranking and paid placement, which dominates the first page presentation to the servers 119 and the local databases 123.

FIG. 2 is a prior art system architecture diagram for information aggregation and searching at an aggregation site. This architecture is suitable for information aggregators such as news aggregation websites, commercial aggregation websites, scientific information aggregation websites, and educational aggregation websites, to name a few. Apps 101 (e.g., browsers or proprietary apps) on user devices 102 can connect over the network 122 to servers 119 with local databases 123, and engage search engines 115 in those servers 119 to search through the local databases 123. This exposes each search to a specific local database 123, making it time-consuming for the user to look through multiple local databases 123. Alternatively, these apps 101 in user devices 102 can connect to an aggregation server 117 and engage the search engine 115 of the aggregation server 117 to search in an aggregated database 121. The aggregation server 117 populates the aggregated database 121 through accesses to the servers 119 and the local databases 123. This architecture has the advantage of giving users options of searching through individual servers 119, search engines 115 and local database 123, or searching through the search engine 115 of the aggregation server 117 and the aggregated database 121 for more concentrated information available with less search effort. This architecture has the advantage of giving users options of searching through individual servers 119, search engines 115 and local database 123, or searching through the search engine 115 of the aggregation server 117 and the aggregated database 121 for more concentrated information available with less search effort. The amount of information in the aggregated database 121 scales with the size and number of local databases 123 and the size and density of information in the aggregated database 121. Nevertheless, the information in the aggregated database 121 is constrained by the information in the combined local databases 123. A disadvantage is that the aggregation site does not allow a user to access information outside of the aggregation.

### SUMMARY

A database-searching network device, an online consignment shopping system, a method for online consignment shopping, and a computer-readable media with related instructions are described.

For one embodiment, a database-searching network device has a network interface and one or more processors. The one or more processors are to receive a request through the network interface. The request is from a user, and is for information from an aggregation of information of multiple local databases. The one or more processors are to search through an aggregated database for a match to the request. The aggregated database has the aggregation of information of the multiple local databases. The one or more processors are to send the information that is from the aggregated database and matches the request, to the user, through the network interface.

For one embodiment, an online consignment shopping center has a network interface and one or more processors. The one or more processors are to receive a request for a consignment article having one or more user-specified measurements. The request is received through the network interface. The consignment article is for potential purchase from an aggregated marketplace that includes multiple consignment vendors. The one or more processors are to search through one or more inventory databases for a match to the request. The one or more inventory databases have inventories of the multiple consignment vendors. The match to the request is as the matching consignment article having the one or more user-specified measurements. The one or more processors are to send information through the network interface. The information is about the matching consignment article having the one or more user-specified measurements, for the potential purchase.

For one embodiment, a method for online consignment shopping is performed by a processing device. The method includes receiving, through a network, a request from a user for a consignment article. The request is for a consignment article having one or more user-specified measurements. The request is for a consignment article for potential purchase from an aggregated marketplace that includes multiple consignment vendors. The method includes searching through one or more inventory databases. The one or more inventory databases have inventories of the multiple consignment vendors. The searching is to identify a match to the requested consignment article that has the one or more user-specified measurements. The method includes sending information to the user through the network. The information is about the match to the requested consignment article having the one or more user-specified measurements, for the potential purchase by the user.

For one embodiment, a tangible, non-transitory, computer-readable media has instructions. The instructions, when executed by a processor, cause the processor to perform various actions. The processor is to receive, through a network, a request from a user. The request is for a consignment article to have one or more user specified measurements, for potential purchase by the user. The potential purchase by the user is from an aggregated marketplace that includes multiple consignment vendors. The processor is to search through one or more inventory databases. The inventory databases have inventories of the consignment vendors. The search is for a match to the requested consignment article to have the one or more user-specified measurements. The processor is to send information about the match to the requested consignment article, to the user, through the network. The match to the requested consignment article is to have the one or more user-specified measurements and be for the potential purchase by the user.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a prior art system architecture diagram for Internet searching.

FIG. 2 is a prior art system architecture diagram for information aggregation and searching at an aggregation site.

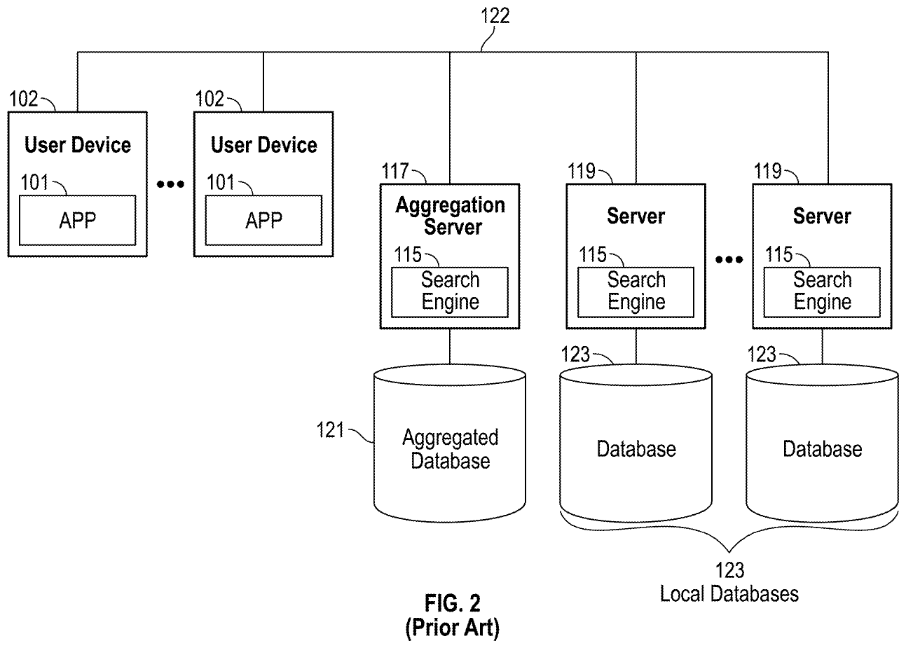

FIG. 3 is a system diagram of an embodiment of an online consignment shopping system that uses information aggregation and searching at an aggregation site.

FIG. 4 depicts an example vendor guided entry form with assisted data entry for the vendor to use to post a consignment article for the online consignment shopping system of FIG. 3.

FIG. 5 depicts an example shopping profile as a consignment article request made by a user of the online consignment shopping system of FIG. 3.

FIG. 6 depicts an example information reply the online consignment shopping system of FIG. 3 generates and sends after finding a match to the user request.

FIG. 7 depicts an example database with example database entries representing consignment articles, suitable for use in the online consignment shopping system of FIG. 3.

FIG. 8 is a flow diagram of a method for online consignment shopping using the online consignment shopping system in various embodiments.

### DETAILED DESCRIPTION

An online consignment shopping system is described that makes use of information aggregation and searching at an aggregation site, with further features specific to various embodiments.

Embodiments of an online consignment shopping system improve upon existing database, searching and network communications systems, with the addition of user-specified measurements and capability for searching through aggregated inventories of consignment vendors for a matching consignment article, as further described herein. A user of the online consignment shopping system, e.g. a consumer, customer or potential customer, may be looking for a used or a secondhand article of clothing or other article for sale by a consignment vendor. The user measures himself or herself for clothing, sports equipment or other personal article, or measures a personal space or comparable existing article, and experiences improved online shopping experience and likelihood of success of finding a matching consignment article. A consignment vendor, looking to increase marketplace for used or secondhand articles of clothing or other articles for sale, experiences increased inventory exposure to customers by participation in an aggregated marketplace supported by embodiments of technologies described below. The consignment vendor also likely experiences increased sales volume and velocity while continuing to provide personal service to the customers through the ability to match the user-specified measurements for these types of consignment articles. These and further benefits and features are available in various combinations in the various embodiments described below.

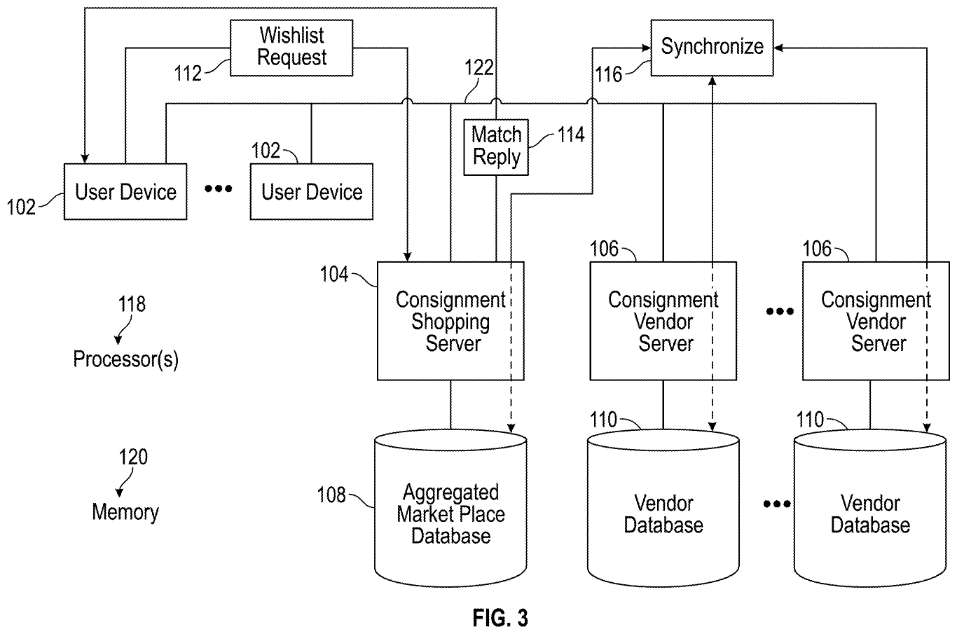

FIG. 3 is a system diagram of an embodiment of an online consignment shopping system. Present system embodiments make use of one or more processors 118 (or a processing device) executing software, memory 120, network(s) 122, network connections and further hardware, software and firmware components, architectures and infrastructure to implement various combinations of the following system components and features.

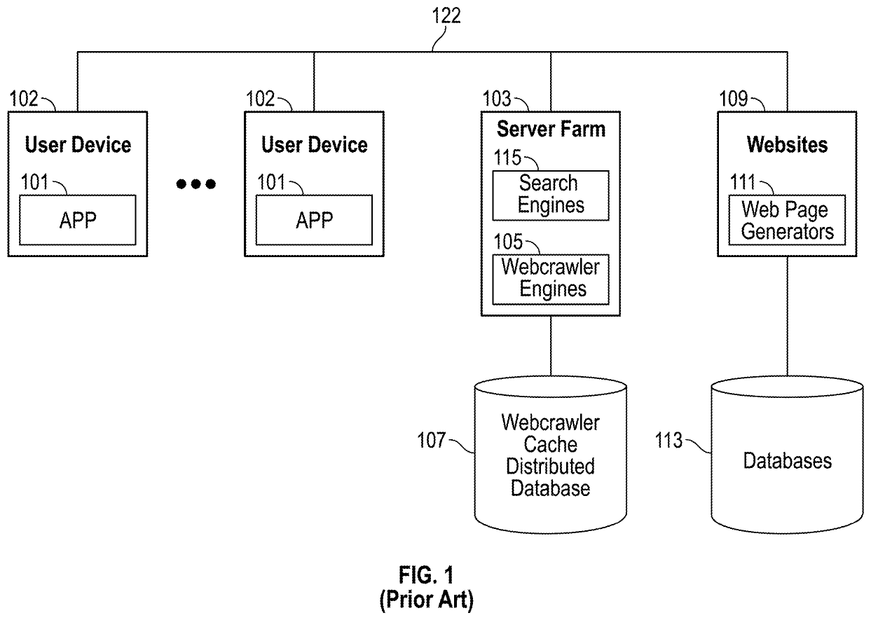

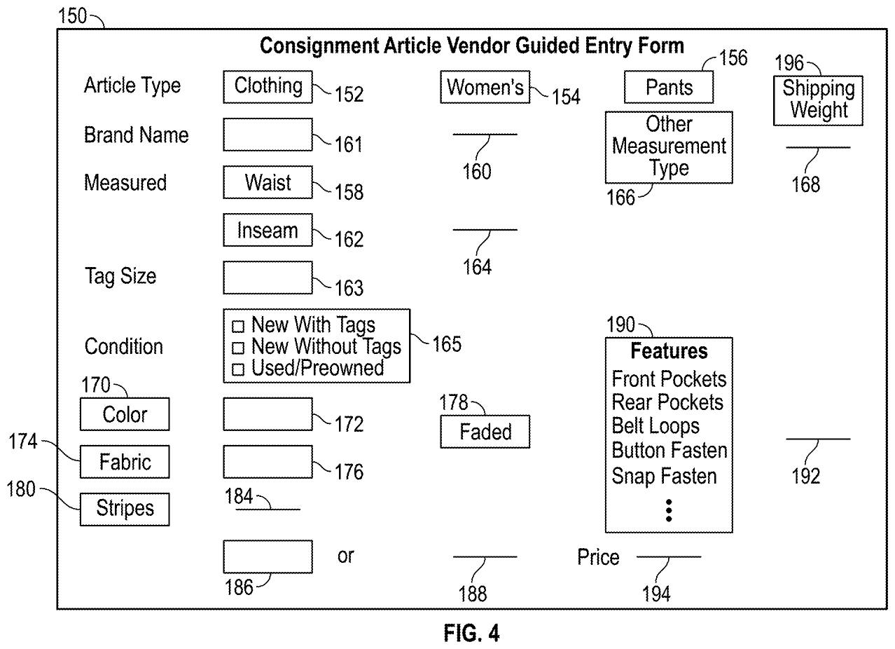

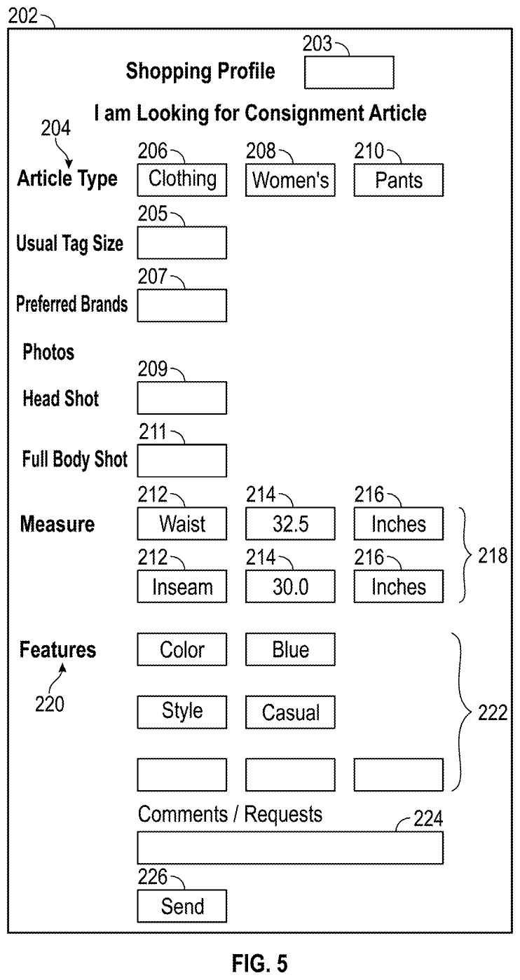

A consignment shopping server 104 is coupled to an aggregated marketplace database 108, to provide assisted data entry to vendors posting consignment articles (see FIG. 4), and provide targeted searching to users seeking consignment articles (see FIG. 5). Continuing with FIG. 3, this targeted searching is implemented, in one embodiment, through service of wish list requests 112 (see FIG. 1) or shopping profiles (see FIG. 5) as can be made from various user devices 102 by users of the system. Consignment vendors using the system each maintain a consignment vendor server 106 coupled to a vendor database 110. In operation, when the consignment shopping server 104 finds a match in the consignment vendor inventories to a consignment article with user-specified measurements in a wish list request 112 or shopping profile from a user and user device 102, the consignment shopping server 104 sends a match reply 114 to the user and user device 102. If the user decides to purchase the matching consignment article, the consignment shopping server 104 makes further arrangements, such as payment, and information exchange with the appropriate consignment vendor server 106, and performs a synchronize operation 116 across the aggregated marketplace database 108 and the vendor databases 110. These various operations can be coordinated immediately, or reconciled at a later time if a consignment vendor server 106 or vendor database 110 is off-line, so that the user experience for consignment shopping through the aggregated marketplace does not depend upon immediate access to a vendor database 110 nor upon all consignment vendor servers 106 and vendor databases 110 being online at the same time as the user is shopping.

For one embodiment of an online consignment shopping system, the support for requests for consignment articles with user-specified measurements is supplied by a website for the aggregated marketplace. For one embodiment, direct user to consignment vendor requests for consignment articles with user-specified measurements are not supported by individual consignment vendor websites. This arrangement could be by agreement of the operator of an aggregated marketplace website and consignment vendors, or as an incentive to the consignment vendors for use of the aggregated marketplace website. For one embodiment, the online consignment shopping system sells subscriptions for its use to consignment vendors, and does not charge a per-sale fee or percentage of sales. Further business models are possible, however, in keeping with the teachings herein.

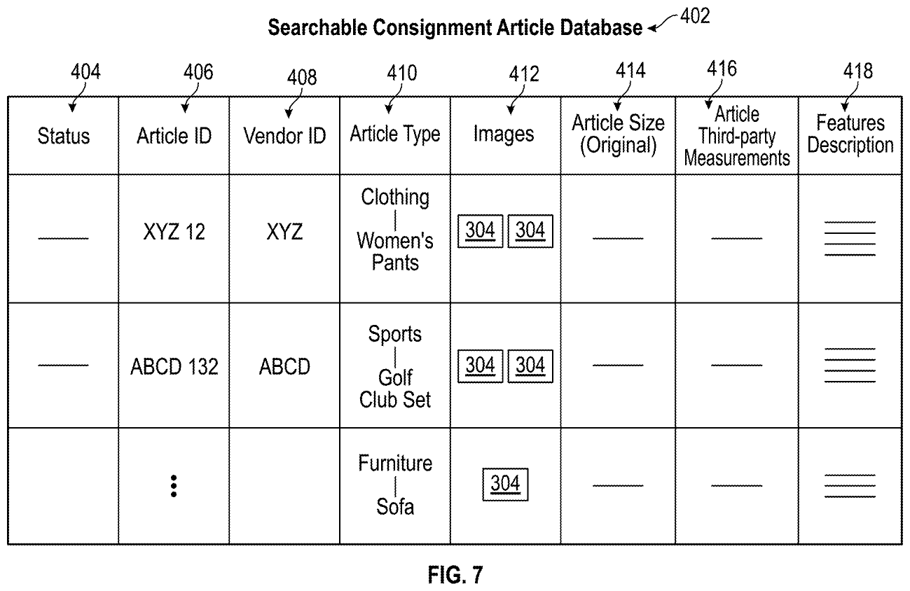

FIG. 4 depicts an example vendor guided entry form 150 with assisted data entry for the vendor to use to post a consignment article for the online consignment shopping system of FIG. 3. For this example, the vendor desires to post a description of a consignment article, namely an article of clothing, women's pants. The online consignment shopping system provides the consignment article vendor guided entry form 150, and assists the vendor in data entry. In turn, the system uses the consignment article vendor guided entry form 150 to generate a searchable consignment article database 402 (see FIG. 7), for targeted searching.

Various embodiments of the system support various combinations of ways the vendor can fill out the information in the vendor guided entry form 150. For example, the consignment shopping server 104 (see FIG. 3) could host a website, and the vendor logs onto the system and views the vendor guided entry form 150 through a browser on a user device 102 (e.g., a smart phone, mobile device, computer, etc.), or through an application programming interface (API) supported by the consignment shopping server 104 and an app 101 operating on a user device 102. The vendor makes entries into the vendor guided entry form 150 through selection (e.g., selection boxes, pop-up or drop-down menus), keyboard entry, voice recognition, etc. Or, the consignment shopping server 104 could email a form to a vendor email account, communicate through text messaging, etc. In a further embodiment, an app executing on a user device 102 steps the vendor through the data entry process and sends the completed form, e.g., through email or text messaging, or posts the completed form to a website.

Example fields and information in the vendor guided entry form 150 include an article type 152, in this example “clothing”, which could be selected from a drop-down list. Selecting “clothing” as the article type 152 then brings up further selection boxes 154, 156 in which the vendor can select “women's” and “pants” or other appropriate descriptors as the assisted entry process proceeds, in one embodiment. The vendor is prompted for and can enter a brand name 161 for the clothing article (or other type of consignment article as appropriate), for example by selecting from a list or entering by keyboard. Since “clothing” and “pants” are selected or otherwise entered by the vendor, the assisted entry process then brings up appropriate measurement fields 158, 162, 166 for third-party measurements that are made by the vendor, an employee or other third-party. Next to the measurement field 158 “waist”, the vendor enters a third-party waist measurement in a measurement dimensions field 160, for example “32.25 inches”. The use of English or metric units could be selectable, or user entered, in variations. Next to the measurement field 162 “inseam”, the vendor enters a third-party inseam measurement in a measurement dimensions field 164, for example “30.1 inches”, again with English or metric units selectable or user entered.

Tag size, the size of the clothing article specified by the manufacturer, is entered in a tag size field 163. The vendor guided entry form 150 prompts the vendor to enter the condition of the clothing article (or other type of consignment article) in a condition field 165, for example by selecting “New With Tags”, “New Without Tags”, or “Used/Preowned”. A tag in this context is a manufacturer-applied tag, for example with manufacturer clothing article size information (e.g., tag size) and/or a universal product code (UPC), also called a bar code.

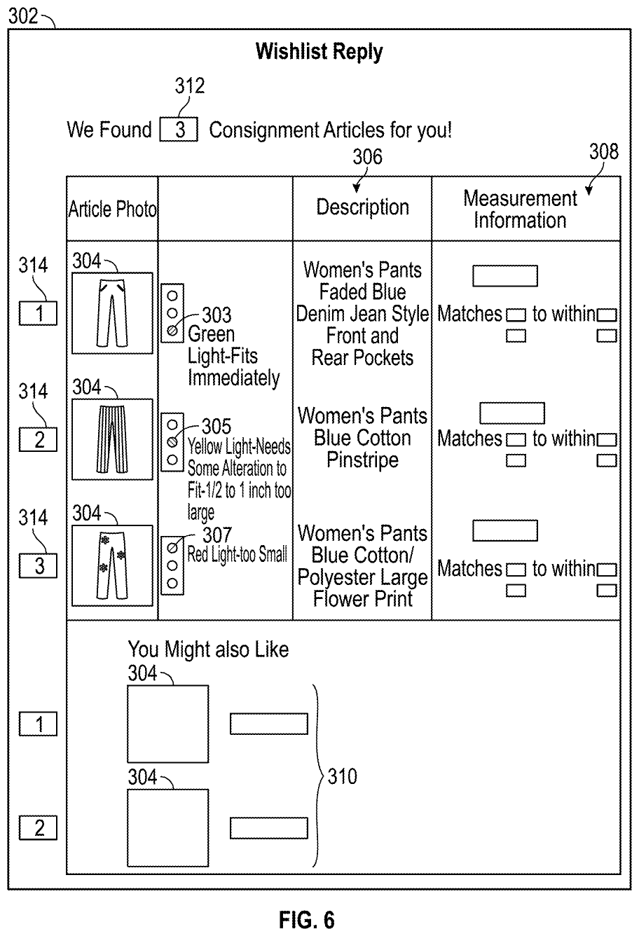

A shipping weight field 196 in the vendor guided entry form 150 is automatically filled in with a default shipping weight by the system, which can be manually overridden. For example, the consignment shopping server 104 could access a list or a database, and look up default shipping weights of articles by article type. As part of the assisted entry process, the appropriate default shipping weight for the article entered by the vendor is then displayed in the vendor guided entry form 150 in the shipping weight field 196. If the vendor, as a user, is not satisfied with the default shipping weight, the vendor manually enters the desired shipping weight in the shipping weight field 196, overriding the default. The system combines the weights of selected items, when the customer as a user is shopping online (see FIGS. 5 and 6), to create the correct total weight of a package, and applies postage charges, in one embodiment.

Further entries are guided by the assisted entry process, and user selectable, such as the system prompting an article characteristic field 170 “color” with a user entry field 172, an article characteristic field 174 “fabric” with the user entry field 176, and a feature selection box 178 “faded” for the fabric. Further features could be selectable from a features list 190, for example front pockets, rear pockets, belt loops, button fastener, snap fastener, etc., are selected and/or entered in a features field 192, for example if not found on the provided features list 190.

Further article characteristics are specified on the vendor guided entry form 150, through the assisted entry process, by the vendor selecting article characteristics checkbox 180, for example “stripes” (as shown) or “other pattern” (not shown). Next to the article characteristics checkbox 180 is a user entry field 184, for the vendor to enter a description of the stripes on the fabric, if selected. Next to the article characteristics checkbox 180 is selectable pattern list 186 for selection of a pattern other than stripes and a user entry field 188 for entry of a description of pattern if not found on the selectable pattern list 186. And, the assisted entry process prompts the vendor to enter a price, in a user entry field 194. Variations on the vendor guided entry form 150 and the assisted entry process are readily developed for various article types, third-party measurements of an article, and article characteristics as appropriate to a given article, in keeping with the teachings herein.

FIG. 5 depicts an example shopping profile 202 as a consignment article request made by a user of the online consignment shopping system of FIG. 3. For this example, the user is looking for a consignment article of clothing, namely, women's pants, and is looking for a match to user-specified measurements of a 32.5 inches waist, 30.0 inches inseam, in a casual style of the color blue. The user may be looking for a preferred brand or brands of clothing (or other consignment article as appropriate). The online consignment shopping system is employed by the user to try to find a match to the user request for the consignment article, as represented in the filled out shopping profile 202. A user may fill out multiple shopping profiles 202, for example when looking for multiple consignment articles, or shopping for other family members, or friends, etc. Each shopping profile 202 has a profile identifier 203, where the user can enter a name or other identifier, e.g., her or his name, the name of a family member or friend, an email address, a number, alphanumeric code or selectable symbol for anonymity, etc.

Various embodiments of the system support various combinations of ways the user can make such a shopping profile 202. For example, the user could be shopping through a website accessed through a browser operating on a user device 102 (e.g., a smart phone, mobile device, computer, etc.), or through an application programming interface (API) supported by the consignment shopping server 104 and an app 101 operating on a user device 102, and make entries into the shopping profile 202 through selection (e.g., selection boxes, pop-up or drop-down menus, etc.), keyboard entry, voice recognition, etc. The website and the user device 102 are connected over a network 122. For another embodiment, the user could write the shopping profile 202 into an email or a text message, and send the email or the text message. Again, the user device 102 is communicating over a network 122 in some manner connected to the consignment shopping server 104, which then processes the information in the shopping profile 202, to search for and perhaps find a matching consignment article for potential purchase by the user.

Example fields and information in the shopping profile 202 include an article type 204, article description, user-specified measurements 218, and features 220. To fill out the shopping profile 202, the user enters “clothing” in an article category field 206, “women's” and “pants” in article descriptor fields 208, 210. The user enters usual tag size in a tag size field 205. Preferred brands may be entered, if desired, in a brands field 207, for example through selection from a drop-down list or keyboard entry. Optionally, in some embodiments, the user can select photos for a head shot 209 and/or full body shot 211, for example from a user photo collection, a camera or other system connectable source. In one embodiment the photos of a person and/or personal measurements are sourced from a third-party application through a linkage to the shopping profile 202.

Continuing in the embodiment of the shopping profile 202 shown in FIG. 5, the user enters “waist” in a measurement category field 212, “32.5” in a measurement dimensions field 214, and “inches” in a measurement units field 216, and “inseam” in another measurement category field 212, “30.0” and “inches” in the corresponding measurement dimensions field 214 and measurement units field 216. In some embodiments, these are user-specified measurements that are more precise than a general size or overall size (e.g., small, medium, large, extra-large, adult's, children's, women's, or men's off the rack sizes). For some embodiments, the system can translate between English and metric units to match inventories and service international or cross-cultural online consignment shopping.

The user enters “color”, “blue”, “style”, “casual”, and/or other features in various features fields 222 in this example, and may also enter comments or requests in a comment field 224. Entry of the various pieces of information may be in random order or guided order, and with required or optional fields, in various embodiments. There may be a “send” or “submit wish list or request” or other soft button 226 request submission mechanism in various implementations of the shopping profile 202.

FIG. 6 depicts an example information reply 302 the online consignment shopping system of FIG. 3 generates and sends after finding a match to the user request. Relating to the various formats and mechanisms for users submitting a shopping profile 202, the online consignment shopping system also could have various embodiments of the information reply 302 and how the information reply 302 is presented to the user and a user device 102. For example, the consignment shopping server 104 could generate and cause the user device 102 to display the information reply 302 through a website or an API supported by the consignment shopping server 104. Or, the consignment shopping server 104 could send an email or text message to a user device 102. A system using multiple such mechanisms could present an immediate reply, indicating a match or no match, and possibly send out a later reply through email or text message if a match is later found among the consignment vendor inventories.

Example fields and information in the wish list information reply 302 include a count field 312 of the total number of consignment articles found as matches, an article number field 314, an article photo 304, an article description 306, and measurement information 308. Generally, most or all of the information in the wish list information reply 302 originates in vendor postings of consignment articles, using the consignment article vendor guided entry form 150 (see FIG. 4). In this example, the wish list reply 302 indicates that the system found “3” consignment articles (in the count field 312). Article “1” (in the article number field 314) has an article photo 304 produced by the consignment vendor and posted to the system, and an article description 306 “women's pants faded blue denim jeans style front and rear pockets” in one or multiple fields. The corresponding measurement information 308 has multiple fields, one of which is third-party measurements of the article, for example measurements made by the consignment vendor and posted to the system (see FIG. 4), e.g., in the vendor database 110 accessed through the consignment vendor server 106. Another field in the measurement information 308 analyzes and describes how close the third-party measurement(s) of the found, matching consignment article are to the user-specified measurement(s). For example, the wish list reply 302 could state that the found, matching women's pants match the user-specified waist measurement to within ½ inch, or 1.0 inch, and/or match the user-specified inseam measurement to within ¾ inch, or 1 cm, etc. In the example wish list information reply 302, the consignment shopping server 104 indicates finding two more matching consignment articles. Article “2” in the article number field 314 is women's pants that are blue cotton pinstripe and match user-specified measurements to within specified values, and article “3” in the article number field 314 is women's pants in blue cotton/polyester with large flower print, matching user-specified measurements to within another set of specified values.

The wish list information reply 302 could also display further information about articles found, such as price, shipping weight, further features, article condition (e.g., as entered in the condition field 165 in the vendor guided entry form 150), other individual notes, etc. Such further information could be in the article description 306, or in various further fields as readily devised. In one embodiment, the wish list information reply 302 summarizes and symbolizes the personal fit of a found consignment article of clothing with a traffic light symbol. For example, adjacent to the article photo 304 of the women's pants in faded blue denim jeans style is a traffic light symbol showing a green light 303 with the text, “Green Light—Fits Immediately”. Adjacent to the article photo 304 of the women's pants in blue cotton pinstripe is a traffic light symbol showing a yellow light 305 with the text, “Yellow Light—Needs Some Alteration to Fit—½ to 1 inch too large”. Adjacent to the article photo 304 of the women's pants in blue cotton/polyester with large flower print is a traffic light symbol showing a red light 307 with the text, “Red Light—too Small”. Further symbols are contemplated.

The system could also specify in the wish list reply 302 further consignment articles 310, each with an article photo 304 and corresponding description, with or without measurement information. These could be articles in the same or a related category, for example companion articles of clothing or accessories if the original category was of clothing, or other related articles for other categories as readily understood.

Referring back to FIG. 3, the third-party measurements of the article and the article photo 304 are originally posted to the vendor database 110 of the consignment vendor, by the consignment vendor using the consignment vendor server 106. And, the consignment shopping server 104 replicates, copies, mirrors, reproduces, etc., the third-party measurements of the article and the article photo 304 in the aggregated marketplace database 108, along with further information identifying the vendor and the article, i.e., synchronizes the databases, as will be further described below with reference to FIG. 7.

FIG. 7 depicts an example database 402 with example database entries representing consignment articles, suitable for use in the online consignment shopping system of FIG. 3. There are many types of databases that could be suitable (e.g., lists, single or multiple index, hash index, trees), and the specific choice of database type and support for database generation, population, access, modification and service are considered implementation details, with the primary requirements being that the database 402 is searchable and suitable for holding appropriate information about consignment articles. For various embodiments, the system could support the same types of databases in the aggregated marketplace database 108 and the vendor databases 110, or support heterogeneous types of databases with appropriate communication for various system accesses and maintenance including the synchronize operation 116 described with reference to FIG. 3.

In the example in FIG. 7, the searchable consignment article database 402 has a status field 404 that records the status of the article. The status field 404 could record, for example, whether the article is being viewed and if so how many live viewers the item has. Status field 404 could indicate if a user has an article in a cart and is in the process of shopping or checkout, the cart expires in 15 minutes, the article is sold, etc. An article identifier (ID) field 406 has identification information for the article, preferably unique, which could include a system-assigned identifier, a vendor assigned identifier, or an aggregated marketplace assigned identifier. The identification information could be, for example article ID “XYZ12” or “ABCD123” that identifies both the vendor by name and the article by number. A vendor ID field 408 identifies the consignment vendor. The vendor ID could be, for example, vendor “XYZ” or vendor “ABCD”. An article type field 410 identifies the type of article. The type of article could be, for example, clothing or more specifically women's pants, sports equipment, more specifically a golf club set, or furniture, more specifically a sofa. There could be multiple fields or subfields for this endeavor. The images field 412 is where the article photos 304 are stored, as digital images. An article size field 414 holds the original sizes of articles. Original sizes could be, for example, manufacturer or label-supplied size. An article third-party measurements field 416 holds measurements made by the consignment vendor (e.g., by an owner, employee, or donor or original owner of the consignment article). These are the measurements the system strives to match to the request, as specified in the user shopping profile 202 for a consignment article. A features description field 418 (or multiple fields in the database 402) is where further description is stored of features not otherwise specified by the article type field 410. These are further features that may be indicated in the wish list reply 302, and that may be used for refinement searching in some embodiments of the online consignment shopping system. Some embodiments of the system may favor, or be exclusive to, articles of clothing, others may support various types of articles in various categories, examples of a small number of which are given herein and further examples of which are readily devised.

With reference back to FIG. 3 and continuing reference to FIG. 7, to synchronize the databases, the consignment shopping server 104 updates the aggregated marketplace database 108 one or more times during the above processes. The consignment shopping server 104 could update the aggregated marketplace database 108, for example, once to show a user has selected but not yet purchased an item and the sale is therefore pending (e.g., the article is in a cart as shown in status field 404 of database 402), and a second time when the sale goes through (e.g., removing the article from the aggregated marketplace database 108 or database 402, or indicating “sold” in status field 404 of database 402). The consignment shopping server 104 synchronizes the corresponding vendor database 110 to the aggregated marketplace database 108 so that both databases 108 and 110 have coherent data in this regard. Later, when the consignment vendor updates the corresponding vendor database 110 to show the article is shipped, or even later to delete the consignment article from the inventory (e.g., after a specified time span to allow for item returns or other aspects of customer satisfaction), the consignment shopping server 104 synchronizes the aggregated marketplace database 108 to the vendor database 110 again so that both databases 108 and 110 have coherent data. For various embodiments, the synchronize operation 116 can take place at scheduled intervals, when triggered by an action, such as a user inquiry, purchase or shipping, on demand, or for other reasons and circumstances in keeping with the teachings herein.

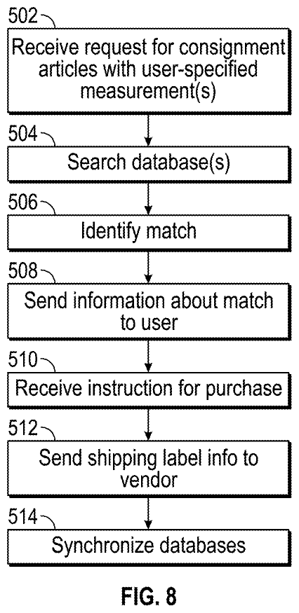

FIG. 8 is a flow diagram of a method for online consignment shopping using the online consignment shopping system in various embodiments. This embodiment of a method is server-centric, and thus can be implemented on and practiced by a server, such as the consignment shopping server depicted in FIG. 3, or more generally by a network device, a processing device, or one or more processors. The method can be embodied in instructions on a computer-readable tangible media. Related methods, such as can be practiced by a user device accessing an embodiment of the consignment shopping server, or as can be practiced by embodiments of the consignment vendor server, are in keeping with the teachings herein.

For an action 502, the system receives a request for a consignment article, with user specified measurements. The request could be in the form of a wish list request or shopping profile, in various formats, and be received over a network through a website, an API, email, a text message, etc.

For an action 504, the system searches one or more databases. The system is searching for a match to the request, attempting to find a matching consignment article that has the user-specified measurements. For one embodiment, the consignment shopping server is searching through the aggregated marketplace database, which can be considered searching by proxy through the vendor databases of the consignment vendors. For an alternative embodiment, the consignment shopping server could search through the vendor databases directly.

For an action 506, the system identifies a match to the requested consignment article. For example, the system identifies a match of a consignment article to a written name or description of the article, and a match of third-party measurements of the article to the user-specified measurements, to within a specified amount.

For an action 508, the system sends information about the match to the user. The system could reply through a website to an inquiry made through the website, or could reply through an email or a text message to an inquiry made through a website or through email or text messaging. The information about the match could include an image of the matching article, description of the article, third-party measurements or how close the third-party measurements of the article are to the user-specified measurements. The information about the match could be sent to the user immediately after the request is received, or at a later time, and to the same user device from which the request originated, or to a differing user device, for various embodiments.

For an action 510, the system receives instructions from the user for purchase of the matching consignment article. This could include authorization to purchase the article, payment information, shipping information, etc. The instructions for purchase could be through a website, an email or text message, etc.

For an action 512, the system sends shipping label information to the vendor. The consignment vendor can use this information to generate and print a shipping label, then print the label, box the article, affix the label to the box and ship the user-selected and purchased consignment article to the user according to the shipping label information.

For an action 514, the system synchronizes the databases. This can be synchronizing the aggregated marketplace database to one or more vendor databases, synchronizing the vendor databases to the aggregated marketplace database, coordinated updates to both aggregated marketplace database and vendor database(s), or other mechanisms as appropriate to the implementations of the databases and circumstances for the synchronization.

With reference to FIGS. 3-8, here is a scenario of a user experience with an embodiment of the online consignment shopping system. The user has visited a local consignment shop, tried on one or two articles of secondhand clothing, and not found a good fit. Next, the user tries an online consignment shop, and finds some selection of possible articles of secondhand clothing, but these only list manufacturer sizes. The user considers purchasing an article of secondhand clothing through a website, having it shipped, trying it on and then sending it back if it does not fit, and decides that is a time-consuming and possibly frustrating exercise, or possibly the site does not accept returns and all sales are final. So, the user decides to try the online consignment shopping system (see FIG. 3), finding the website for an aggregated consignment marketplace through an online search, advertisement, word-of-mouth, social media site, etc. Multiple vendors have posted consignment articles, using the consignment article vendor guided entry form 150 with assisted data entry (see FIG. 4). These consignment articles are aggregated in the searchable consignment article database 402 (see FIG. 7), a version of the aggregated marketplace database 108 (see FIG. 3). The user enters a name or description of an article of clothing (in article category field 206 and article descriptor fields 208 and 210), and user-specified measurements (in measurement dimensions fields 214) for the desired article of clothing, into an easily filled-out shopping profile 202 (see FIG. 5) that acts as a wish list request (see FIG. 3), and sends the shopping profile 202. The consignment shopping server 104 performs a targeted search in the aggregated marketplace database 108, using the method for online consignment shopping (see FIG. 8). A wish list reply 302 (see FIG. 6) comes back to the user (user device 102, see FIG. 3) through the website, or is emailed or messaged sometime later, announcing that several (count field 312) consignment articles are available from the aggregated consignment marketplace. Each consignment article of clothing has an image, i.e., a photo (article photo 304) of the actual secondhand article of clothing, and information (measurement information 308) about the third-party measurements of the used article of clothing, such as the actual third-party measurements, comparison to the user-specified measurements, and/or symbolized summary of fit (e.g., a traffic light symbol 303, 305, 307). Noting the satisfaction and returns policy, and the closeness of fit of each article according to the third-party measurements, the user decides to purchase two consignment articles of clothing, and proceeds through the online purchase process. The online consignment shopping system handles all details to and from the consignment vendor, so that the customer has a seamless online consignment shopping experience. Upon receiving the selected, shipped, matching consignment articles of clothing, the user is delighted to find fit matched so well and decides to keep both, or perhaps keeps one and returns the other, but in any case is satisfied with the outcome. The consignment vendor is pleased both to have increased business beyond brick and mortar shoppers and beyond an individual consignment vendor website, and to have a satisfied customer, all with minimal extra effort. Embodiments of the online consignment shopping system described herein thus have improved customer satisfaction, improved vendor satisfaction, and improved database, searching and network communications technologies by giving such systems added features and capabilities that better meet consumer and vendor needs and extend the customer and vendor connection. Further, and more specifically, the embodiments of the online consignment shopping system present a solution to a technologically driven problem of search results for articles available from small-business vendors being buried on later pages of search results and going unnoticed by users of large-scale search engines.

The foregoing description, for the purpose of explanation, has been described with reference to specific embodiments. However, the illustrative discussions above are not intended to be exhaustive or to limit the invention to the precise forms disclosed. Modifications and variations are possible in view of the above teachings. The embodiments were chosen and described in order to best explain the principles of the embodiments and practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein.

What is claimed is:

1. A database-searching network device, comprising:
a network interface; and
one or more processors, to:
receive, through the network interface, a request from a user for information from an aggregation of information of a plurality of local databases;
search through an aggregated database having the aggregation of information of the plurality of local databases, for a match to the request; and
send, to the user through the network interface, the information that is from the aggregated database and matches the request.

2. An online consignment shopping system, comprising:
a network interface; and
one or more processors, to:
receive, through the network interface, a request for a consignment article having one or more user-specified measurements, for potential purchase from an aggregated marketplace comprising a plurality of consignment vendors;
search through one or more inventory databases having inventories of the plurality of consignment vendors for a match to the request, as the matching consignment article having the one or more user-specified measurements; and
send, through the network interface, information about the matching consignment article having the one or more user-specified measurements, for the potential purchase.

3. The online consignment shopping system of claim 2, wherein the one or more processors are further to synchronize an aggregated inventory database and vendor inventory databases of the plurality of consignment vendors, wherein the one or more inventory databases comprises the aggregated inventory database.

4. The online consignment shopping system of claim 2, wherein to send the information about the matching consignment article comprises to send a notification by email or text messaging.

5. The online consignment shopping system of claim 2, wherein:
the request comprises a written name or description of an article of clothing;
the matching consignment article comprises a used article of clothing;
the one or more user-specified measurements comprise one or more measurements more precise than general size or overall size; and
the match comprises a match of the used article of clothing to the written name or description of the article of clothing and a match of one or more third-party measurements of the used article of clothing to the one or more user-specified measurements to within a specified amount.

6. The online consignment shopping system of claim 2, wherein the information about the matching consignment article comprises an image of a used article, from the one or more inventory databases, and information relating to one or more third-party measurements of the used article.

7. The online consignment shopping system of claim 2, wherein:
such requests for consignment articles with the user-specified measurements are supported by a website for the aggregated marketplace; and
direct user to consignment vendor requests for the consignment articles with the user-specified measurements are not supported by individual consignment vendor websites.

8. The online consignment shopping system of claim 2, wherein the one or more processors are further to send information for printing a shipping label to one of the plurality of consignment vendors having the matching consignment article, responsive to receiving, through the network interface, an instruction to purchase the matching consignment article.

9. The online consignment shopping system of claim 2, wherein the one or more processors are further to:
provide assisted data entry, including determination of default shipping weights for consignment articles, to a plurality of vendors;
receive a plurality of consignment article entry forms from the plurality of vendors and resulting from the assisted data entry; and
generate the aggregated database, based on the plurality of consignment article entry forms.

10. A method for online consignment shopping, performed by a processing device, comprising:
receiving, through a network, a request from a user for a consignment article having one or more user-specified measurements, for potential purchase from an aggregated marketplace comprising a plurality of consignment vendors;
searching through one or more inventory databases having inventories of the plurality of consignment vendors to identify a match to the requested consignment article having the one or more user-specified measurements; and
sending, to the user through the network, information about the match to the requested consignment article having the one or more user-specified measurements, for the potential purchase by the user.

11. The method for online consignment shopping of claim 10, further comprising:
synchronizing an aggregated inventory database and vendor inventory databases of the plurality of consignment vendors, wherein the one or more inventory databases comprises the aggregated inventory database.

12. The method for online consignment shopping of claim 10, wherein the sending the information about the match comprises sending an email or a text message to the user.

13. The method for online consignment shopping of claim 10, wherein:
the request comprises a wish list item comprising a written name or description of an article of clothing;
the consignment article comprises a used article of clothing;
the one or more user-specified measurements comprise one or more personal measurements of the user that are to a greater degree of precision than general size or overall size; and
the match comprises a match of the used article of clothing to the written name or description of the article of clothing and a match of one or more third-party measurements of the used article of clothing to the one or more user-specified measurements to within a specified amount.

14. The method for online consignment shopping of claim 10, wherein the information about the match to the requested consignment article comprises an image of a used article, from the one or more inventory databases, and measurement information about the used article including one or more third-party measurements of the used article or how close are the one or more third-party measurements of the used article to the one or more user-specified measurements.

15. The method for online consignment shopping of claim 10, further comprising:
supporting such requests for consignment articles with the user-specified measurements are by a website for the aggregated marketplace, wherein direct user to consignment vendor requests for the consignment articles with the user-specified measurements are not supported by individual consignment vendor websites of the plurality of consignment vendors.

16. The method for online consignment shopping of claim 10, further comprising:
sending, through the network, information for printing a shipping label to one of the plurality of consignment vendors having the consignment article that matches the request, responsive to receiving, through the network, an instruction from the user to purchase the consignment article that matches the request.

17. A tangible, non-transitory, computer-readable media having instructions thereupon which, when executed by a processor, cause the processor to:
receive, through a network, a request from a user for a consignment article to have one or more user-specified measurements, for potential purchase by the user from an aggregated marketplace comprising a plurality of consignment vendors;
search through one or more inventory databases having inventories of the plurality of consignment vendors for a match to the requested consignment article to have the one or more user-specified measurements; and
send, to the user through the network, information about the match to the requested consignment article to have the one or more user-specified measurements, for the potential purchase by the user.

18. The computer-readable media of claim 17, wherein the instructions further cause the processor to:
synchronize an aggregated inventory database and vendor inventory databases of the plurality of consignment vendors, wherein the one or more inventory databases comprises the aggregated inventory database.

19. The computer-readable media of claim 17, wherein to send the information about the match to the requested consignment article, the instructions cause the processor to:
send an email or a text message that includes the information about the match to the requested consignment article, through the network.

20. The computer-readable media of claim 17, wherein:
the request comprises a written name or description of an article of clothing, as a wish list item;
the consignment article comprises a used article of clothing;
the one or more user-specified measurements comprise one or more measurements of the user that are more precise than general size or overall size; and
the match comprises a match of the used article of clothing to the written name or description of the article of clothing and a match of one or more third-party measurements of the used article of clothing to the one or more user-specified measurements to within a specified amount.

21. The computer-readable media of claim 17, wherein to send the information about the match to the requested consignment article, the instructions cause the processor to:
send an image of a used article, from the one or more inventory databases, and dimension information about the used article including one or more third-party measurements of the used article or how close are the one or more third-party measurements of the used article to the one or more user-specified measurements.

22. The computer-readable media of claim 17, wherein the instructions further cause the processor to:
send, through the network, information for printing a shipping label to one of the plurality of consignment vendors having the consignment article that matches the request, responsive to receiving, through the network, an instruction from the user to purchase the consignment article that matches the request.
